(19) United States
(12) Patent Application Publication
(10) Pub. No.: US 2016/0125331 A1
(43) Pub. Date: May 5, 2016

(54) AUTOMATED AGRICULTURAL ACTIVITY DETERMINATION SYSTEM AND METHOD

(71) Applicant: AgriSight, Inc., Ann Arbor, MI (US)

(72) Inventors: Jesse Vollmar, Ann Arbor, MI (US); John Shriver, Ann Arbor, MI (US); Damian Wieczorek, Ann Arbor, MI (US); Ellis Valentiner, Ann Arbor, MI (US); Hung Truong, Ann Arbor, MI (US)

(21) Appl. No.: 14/929,055

(22) Filed: Oct. 30, 2015

Related U.S. Application Data
(60) Provisional application No. 62/072,911, filed on Oct. 30, 2014.

(51) Int. Cl. G06Q 10/06; H04W 4/02

(52) U.S. Cl. CPC G06Q 10/06311; H04W 4/021

(57) ABSTRACT

A method for autonomous record population with past agricultural treatments, including: monitoring a user device parameter of a user device for a trigger event, wherein the user device is associated with a user account; automatically initiating sensor measurement recordation with a user device in response to occurrence of the trigger event; recording a set of sensor measurements over a treatment time period; automatically identifying a past agricultural treatment based on the sensor measurements; and automatically generating a record of the past agricultural treatment for the user account, the record including: the treatment time period, an identifier for the past agricultural treatment, and a field identifier for the predefined geofence.

### CROSS-REFERENCE TO RELATED APPLICATIONS

This application claims the benefit of U.S. Provisional Application No. 62/072,911 filed 30 Oct. 2014, which is incorporated in its entirety by this reference.

### TECHNICAL FIELD

This invention relates generally to the agricultural field, and more specifically to a new and useful system and method for automatically recording agricultural activities in the agricultural field.

### BACKGROUND

The agricultural field has historically lacked a digital management tool that tracks field actions (crop or field treatments), wherein the vast majority of agricultural management is performed by pen and paper. However, digital agricultural tracking and management presents new challenges. Namely, digital agricultural tracking and management oftentimes requires data entry, which can be cumbersome and time consuming due to the large amount of data to be entered, such as the type of treatment applied, what was used in the treatment, which field was treated, who performed the treatment, and so on. This can lead to reduced- or non-use of the digital tracking and management tool.

Thus, there is a need in the agricultural field to create a new and useful system and method for automated treatment tracking. This invention provides such new and useful system and method.

### BRIEF DESCRIPTION OF THE FIGURES

FIG. 1 is a schematic representation of the method of automatic agricultural action tracking and management.

FIG. 2 is a schematic representation of an example of the method.

FIG. 3 is a schematic representation of a variation of the modules.

FIG. 4 is a first specific example of module use.

FIG. 5 is a second specific example of module use.

FIG. 6 is a schematic representation of an example of the method wherein the treatment is determined based on sensor measurements.

FIG. 7 is a schematic representation of an example of the method wherein the treatment is determined based on the equipment identifier and treatment time relative to a prior treatment.

FIG. 8 is a schematic representation of an example of the method wherein a service provider's service provision confirmation information is further used to track farmer field actions.

FIG. 9 is a specific example of an automatically generated activity tracking record associated with a user account.

FIG. 10 is a specific example of an automatically generated activity tracking record for a set of fields associated with a user account.

FIG. 11 is a specific example of an automatically generated activity tracking record for a set of equipment associated with a user account.

FIG. 12 is a specific example of a treatment schedule defining previously performed treatments and scheduled future treatments.

FIG. 13 is a specific example of a list of equipment associated with a user account.

FIG. 14 is a specific example of a dashboard for a user account, including automatically generated and/or user-generated, previously performed treatments, instantaneous and forecasted weather associated with the geographic locations of the fields associated with the user account, and other information.

### DESCRIPTION OF THE PREFERRED EMBODIMENTS

The following description of the preferred embodiments of the invention is not intended to limit the invention to these preferred embodiments, but rather to enable any person skilled in the art to make and use this invention.

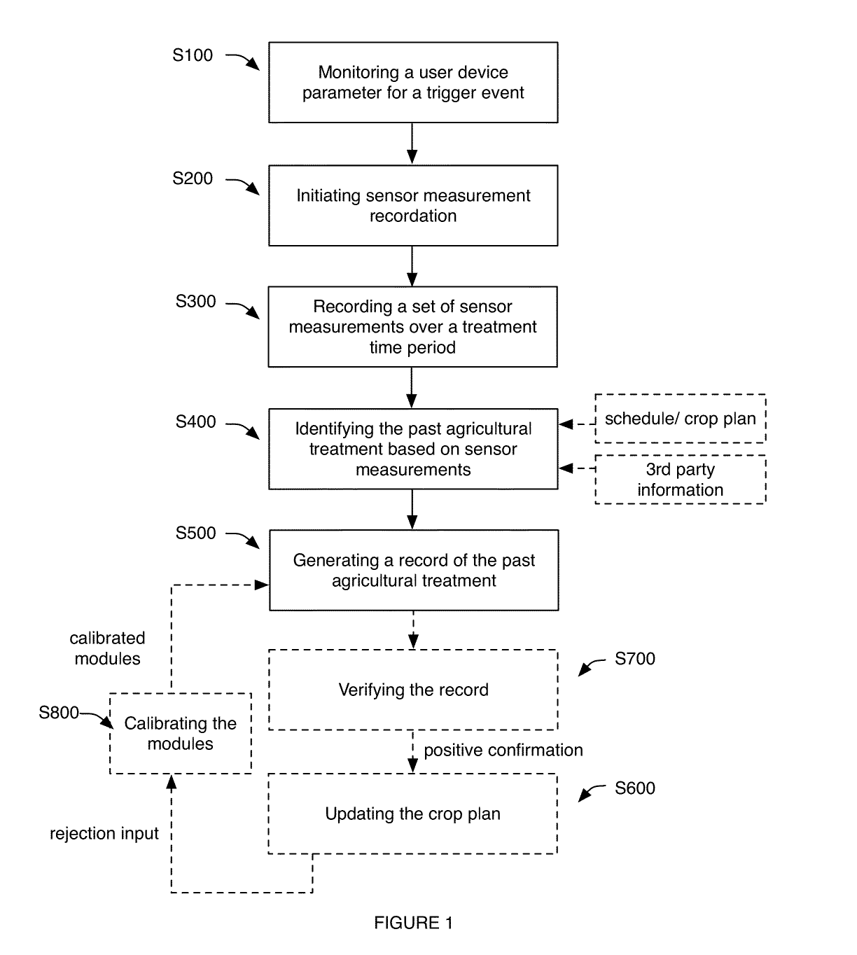

As shown in FIG. 1, the method for automatically recording agricultural treatments includes: monitoring a user device parameter of a user device for a trigger event S100; initiating sensor measurement recordation in response to occurrence of the trigger event S200; recording a set of sensor measurements over a treatment time period S300; identifying the past agricultural treatment based on the sensor measurements S400; and generating a record of the past agricultural treatment S500.

The method functions to enable automated identification of prior agriculture treatments for farmers (e.g., automatically track treatments applied to the respective crops or field, with little or no farmer input), but can alternatively or additionally be used to automatically populate a crop plan (e.g., populate a schedule for the field with past treatments, populate an empty timeslot in a schedule for the field with past treatments performed during the timeslot, etc.), verify performance of scheduled agricultural treatments for the field, enable automated service provision entry for agricultural service providers, or for any other suitable entity.

The farmer is preferably an entity that owns a set of crop fields, wherein crops or other plants are preferably grown in the crop fields. The farmer can additionally own and be associated with agricultural equipment, one or more user devices, or any other suitable component. The farmer can additionally employ employees, wherein each of the employees can be associated with a different user device. The farmers and/or employees are preferably each associated with a unique user identifier, but can alternatively or additionally share a common identifier. The service providers preferably provide services to the farmers, such as renting equipment, providing treatment services (e.g., harvesting crops, spraying crops, analyzing crops, etc.), or providing any other suitable service. The service provider is preferably associated with one or more treatments, and can own and be associated with agricultural equipment, one or more user devices, or any other suitable component. The service provider can additionally employ employees that provide the service to customer farmers, wherein each of the employees can be associated with a user device. The employees are preferably associated with a unique user identifier, but can alternatively share a common identifier.

The method can additionally function to provide scheduling information, information for billing purposes, information for payroll purposes, information for treatment recommendations, supply forecasting (e.g., for suppliers of seed, fertilizer, or other treatment material), cost forecasting, yield forecasting, maturity forecasting, growth stage forecasting, or provide information for use in any other suitable manner. In a specific variation, the method functions to determine the type of treatment performed, the time of treatment performance, the location of treatment performance, and/or the entity for which the treatment was performed. The method can additionally function to determine treatment details, such as the brand of the treatment material, the amount of treatment material used, the cost of the treatment material, or any other suitable detail. The method and/or portions thereof can be performed automatically (e.g., in real time or near-real time), in response to receipt of a manual input, or at any other suitable time.

In a specific example, the method can include: determining whether a user or agricultural equipment is in a user's field; in response to user or equipment location within the field, determining whether sensor measurements should be recorded; in response to determination that the sensor measurements should be recorded, recording sensor measurements (e.g., by the user device, agricultural equipment, or other data logger); in response to sensor measurement recordation, determining a set of treatment parameters characterizing the recorded treatment based on the sensor measurements; and creating and storing a record of the performed treatment, including the treatment parameters, in the system. The record can be used to populate a schedule of past treatments, update the parameters of a previously scheduled treatment in a crop plan, generate recommendations for future treatments, or be otherwise used. User or equipment location within the analysis field can be determined based on the user device's geographic location, equipment's geographic location, or otherwise determined. Sensor measurements should be recorded: when the high-precision user device or equipment geographic location falls within the field geofence, when an initial sample of the sensor measurements match a predetermined pattern (e.g., moving faster than a walking pace, etc.), when auxiliary data indicate a high probability of treatment performance (e.g., there was a treatment scheduled in the corresponding crop plan, neighboring fields are being treated or have been treated recently, etc.), or at any other suitable time.

### 1. Modules.

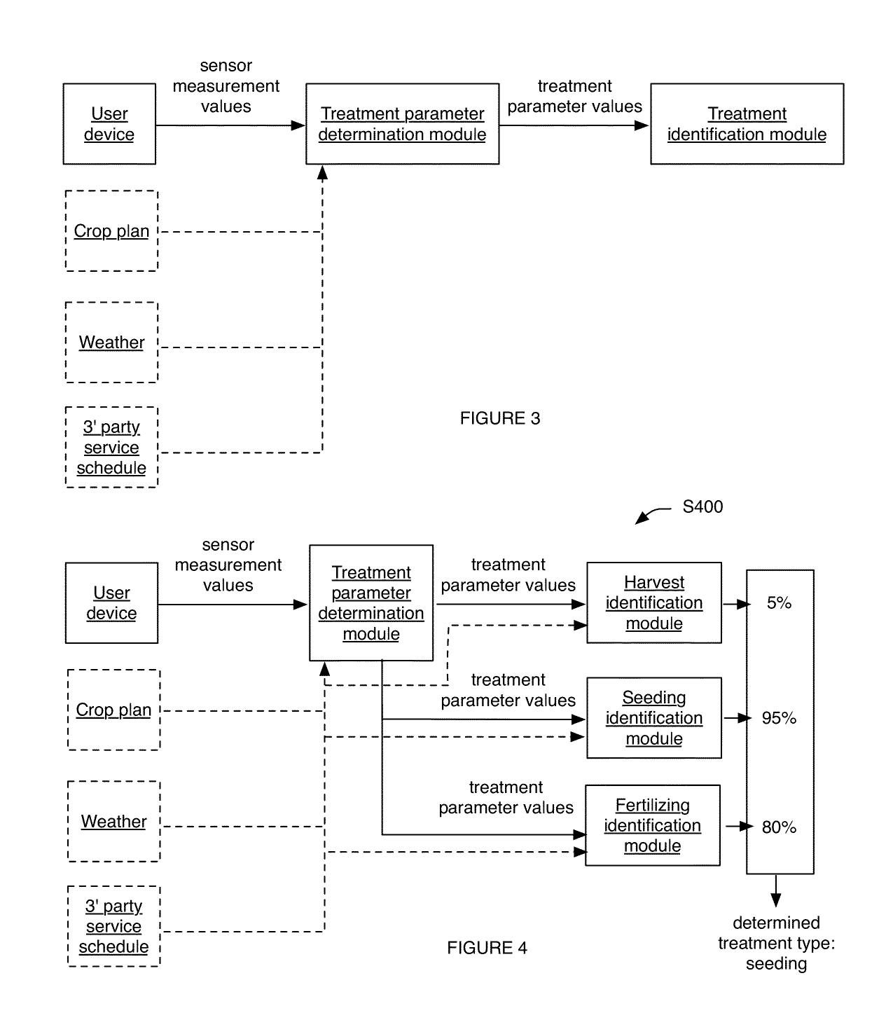

The method is preferably performed by a plurality of modules, but can alternatively be performed by any other suitable module running a set of computational models. As shown in FIG. 3, the plurality of modules can include: a treatment parameter determination module, a treatment identification module, and/or any other suitable computation module. Each module of the plurality can be entirely or partially executed, run, hosted, or otherwise performed by: a remote computing system (e.g., a server), a user device (e.g., a native application, web application, or firmware on the user device), or by any other suitable computing system. When one or more modules are performed by the remote computing system, the remote computing system can remotely (e.g., wirelessly) communicate with or otherwise control user device operation. The data used by the modules preferably includes the set of sensor measurement values recorded for the recorded treatment (e.g., the instantaneous treatment being analyzed), auxiliary data (e.g., third party data, weather data, etc.), historic sensor measurement values for past treatments, user inputs, or any other suitable set of data.

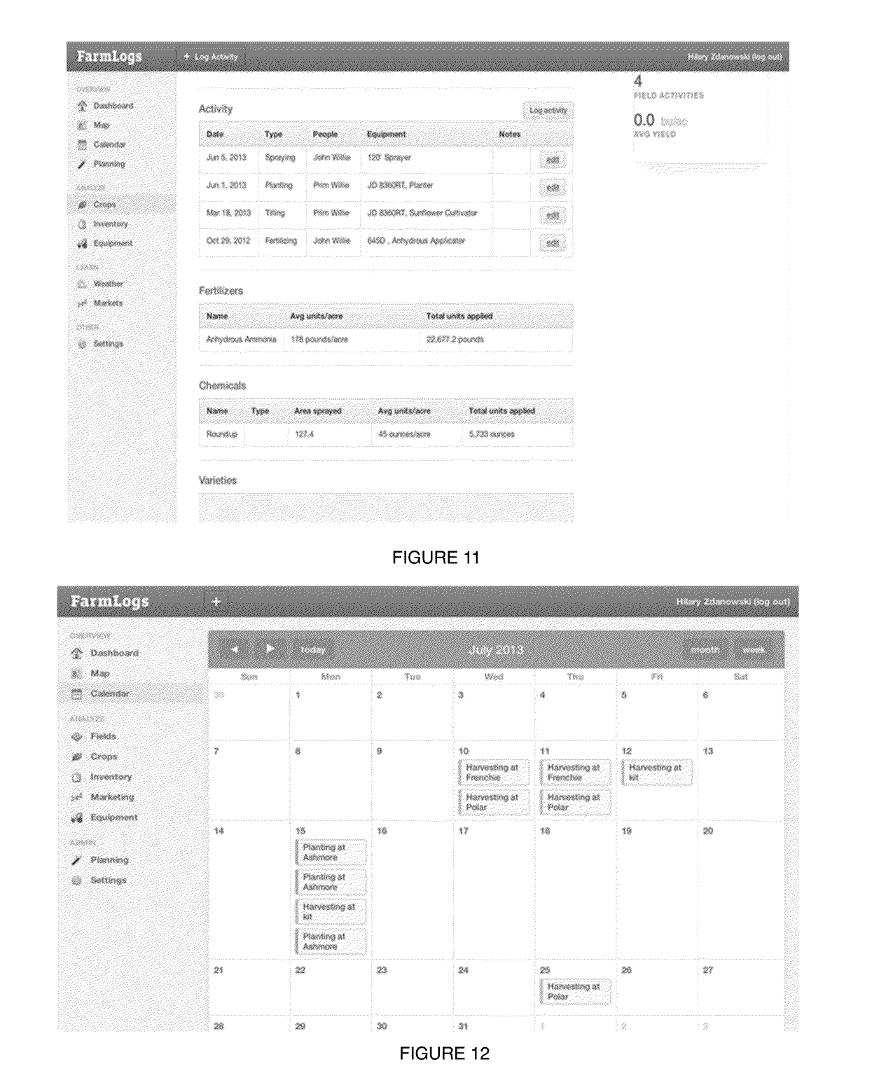

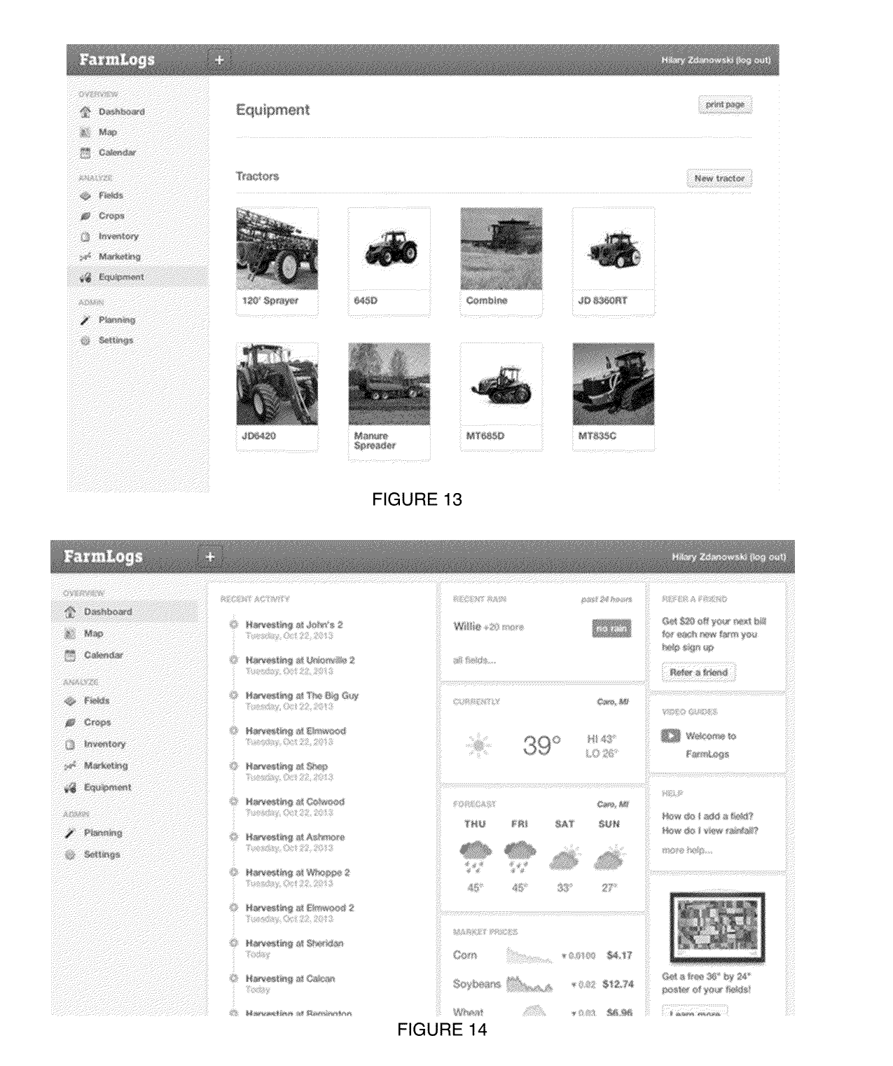

The treatment parameter determination module functions to determine values for each of a set of treatment parameters characterizing the treatment based on features extracted from the sensor measurement values. The treatment parameter values can be used to: identify the treatment, generate maps of the field (e.g., yield maps, crop performance prediction maps, etc.; example shown in FIG. 10), or be used in any other suitable manner. Examples of sensor measurements include: user device orientation sensor measurements (e.g., accelerometer data, gyroscope data, etc.), user device location measurements, agricultural equipment sensor measurements (e.g., auger encoder measurements, motor encoder measurements, current or voltage sensor measurements, temperature sensor measurements, control instructions, etc.), or include any other set of suitable sensor measurements. Examples of features can include: value patterns over time, derivative values over time, values or derivative values as a function of location, differences between a first and second sensor measurement value, the minimum sensor measurement value, the minimum sensor measurement value, or include any other suitable feature. Examples of treatment parameters can include: the treatment type, treatment material amount, the treatment time, the treated field (e.g., the field identifier associated with the predefined geofence), the agricultural equipment used (e.g., equipment identifier or equipment type), traversal path, traversal velocity, traversal acceleration, acceleration pattern (e.g., due to agricultural equipment operation), treatment equipment power parameters (e.g., voltage provision values, current provision values, time duration, etc.), type of treatment applied, treatment application rate, the type of crop, the maturity of the crop, rate of application, rate of mass flow, harvested material moisture levels, or any other suitable treatment parameter, some examples of which are shown in FIG. 11. The treatment parameter values can be automatically determined from the sensor measurements, received from the user, extracted from the crop plan (e.g., determined from the auxiliary information), or otherwise determined.

The treatment parameter determination module can be a: probabilistic module, heuristic module, deterministic module, clustering module, unsupervised machine learning module (e.g., artificial neural network, association rule learning, hierarchical clustering, cluster analysis, outlier detection), supervised learning module, semi-supervised learning module, deep learning module, or any other suitable module leveraging any other suitable machine learning method or combination thereof. In one example, each treatment parameter can include a set of possible treatment parameter values, wherein the treatment parameter determination module can calculate a probability for each possible treatment parameter value. The treatment parameter values associated with the agricultural treatment for which the sensor measurements were recorded can be those having the highest probability. However, the treatment parameter determination module can determine the treatment parameter values in any other suitable manner. The treatment parameter determination module can be run or updated: once; every year (e.g., after crop harvest, after crop yield is determined, etc.); every time the method is performed; every time a negative confirmation input is received (e.g., every time a second treatment identifier is received in lieu of the determined treatment identifier); or at any other suitable frequency.

The treatment identification module functions to determine an identifier for the agricultural treatment based on sensor measurements were recorded during the agricultural treatment (recorded treatment). The treatment identifier can be a treatment type (e.g., a non-unique or shared identifier), a user-specified treatment identifier (e.g., a unique identifier), or be any other suitable identifier for the treatment. The treatment identifier is preferably determined based on a subset (e.g., all or a portion) of the treatment parameter values determined by the treatment parameter determination module, but can alternatively be determined based on auxiliary information, the time of the year, the time relative to the growing season, or be identified based on any other suitable information. Auxiliary information can be associated with the crop field, associated with the treatment, or otherwise associated with the treatment. Auxiliary information associated with the crop field can include: a crop plan or projected schedule, weather for the field, soil data for the field, cultivar assigned to the field, pests or growth anomalies detected within the field, past recommendations for the field, previous treatment history (e.g., automatically generated by the method or entered by the user), previous crop history, current crop status, activities detected on nearby fields, or any other suitable field-related information. Nearby fields can be other fields geographically contiguous to the field for which the past treatment is being determined (analysis field); fields within a predetermined geographic distance from the analysis field (e.g., within 100 miles of the analysis field, within your state, etc.); other fields geographically related to the analysis field, such as through terrain (e.g., being downhill from the other field), wind (e.g., being downwind from the other field), water (e.g., downstream from the other field, connected to the other field by groundwater); or any other suitable field. Auxiliary information associated with the treatment can include: the set of geographic locations or regions treated during the same session or by the same user account within a predetermined time period, the user or entity that performed the treatment, the user or entity associated with the property that received the treatment, the treating equipment, a predetermined schedule for treatments associated with the entity, past purchases and/or current inventory for the entity, the treatments being performed on nearby fields, or any other suitable information. In one example, the treatment identification module can determine the probability of the recorded treatment being a given treatment type based on the percentages of other fields (or entities) performing the given treatment type within a predetermined time duration from the treatment time. The other fields or entities preferably share parameter values with the analysis field or user account (e.g., similar geographic region, soil type, cultivar, crop, management practices, etc.), but can alternatively have little or nothing in common with the analysis field or user account. In a specific example, if 60% of the neighboring fields are being seeded, 10% of the neighboring fields are being tilled, and 20% are being fertilized, the probability that the recorded treatment was seeding can be higher than the probability that the recorded treatment was tilled or fertilized, particularly if a tilling treatment had already been recorded for the analysis field. However, the treatment identifier can be otherwise determined.

The treatment identification module can be a: probabilistic module, heuristic module, deterministic module, clustering module, unsupervised machine learning module (e.g., artificial neural network, association rule learning, hierarchical clustering, cluster analysis, outlier detection), supervised learning module, semi-supervised learning module, deep learning module, or any other suitable module leveraging any other suitable machine learning method or combination thereof.

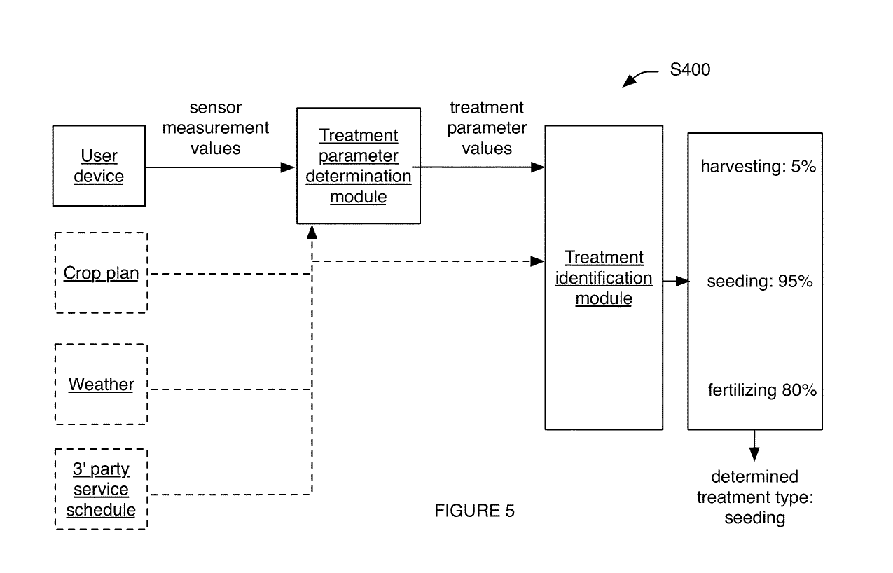

In a first variation, the treatment identification module generates a probability for each of a plurality of possible treatment types (e.g., 90% probability that the agricultural treatment was a seeding treatment, 54% probability that the agricultural treatment was a harvesting treatment, etc.). In a first embodiment of the first variation, the probabilities for each of the plurality of possible treatment types are determined by a single treatment identification module, an example of which is shown in FIG. 5. In a second embodiment of the first variation, an example of which is shown in FIG. 4, the probabilities for each of the plurality of possible treatment types are determined by a different treatment identification modules, wherein each treatment identification module is associated with a single possible treatment type and determines the probability that the recorded treatment is the respective possible treatment type. However, the probabilities can be otherwise determined. The treatment identifier identified for the agricultural treatment can be the identifier associated with the possible treatment type having the highest probability, but can alternatively be any other suitable treatment identifier. Each possible treatment type can be associated with a different set of treatment parameters, but can alternatively be associated with the same set of treatment parameters. The set of associated treatment parameters are preferably used in determining the probability of the recorded treatment being the possible treatment type, but can alternatively be otherwise used. In one example, a first possible treatment type (e.g., seeding) can be associated with a first set of treatment parameters (e.g., traversal path or course, velocity pattern, time of year, and user device vibration), while a second possible treatment type (e.g., harvesting) can be associated with a second set of treatment parameters (e.g., velocity pattern, equipment power provision patterns, presence of a harvesting treatment in the crop plan for the field). However, the probabilities can be otherwise determined.

In a second variation, the treatment identification module can compare the treatment parameter values (determined from the sensor measurements) with one or more sets of reference treatment parameter values, wherein each set of reference treatment parameter values can be associated with a different possible treatment type. For example, thinning can be associated with highly variable equipment power provision, while seeding can be associated with a distinct traversal velocity pattern and distinct equipment power provision pattern. However, the treatment can be otherwise identified and/or characterized. However, the treatment identification module can determine the treatment parameter values in any other suitable manner.

The treatment identification module can be run or updated: once; every year (e.g., after crop harvest, after crop yield is determined, etc.); every time the method is performed; every time a negative confirmation input is received (e.g., every time a second treatment identifier is received in lieu of the determined treatment identifier); or at any other suitable frequency. In one example, treatment identification module calibration can include: determining a first treatment identifier for the agricultural treatment, presenting the first treatment identifier as the identifier for the agricultural treatment to the user, receiving a second treatment identifier from the user as the identifier for the agricultural treatment, and updating the treatment identification modules for the first and second possible treatment types identified by the first and second treatment identifiers, respectively, wherein the second treatment identifier is used as the ground truth to train the models. Updating the treatment identification modules can include re-determining the treatment identification equations, considered features, weights, sub-modules and/or other treatment identification module parameters; iterating through different permutations until the probability that the recorded treatment was the second treatment is higher than the probabilities for the remainder of the possible treatment types; or otherwise updated. The updated treatment identification modules are preferably used to characterize (e.g., identify) subsequent agricultural treatments, based on the respective sensor measurements. However, the updated treatment identification modules can be otherwise used. However, the treatment identification modules can be otherwise calibrated.

The method can additionally include a geofencing module that functions to determine the predefined geofences. The geofences preferably delineate the boundaries of a field, but can alternatively represent the boundaries of any other suitable geographic region. The geofences are preferably each associated with one or more user accounts, but can alternatively be associated with any other suitable set of entities. In a first variation, the geofences are received from a user account (e.g., at a map or other user interface). In a second variation, the geofences are automatically determined. In one embodiment of the second variation, the geofences can be automatically determined from political records (e.g., county records, property records, etc.). In a second embodiment of the second variation, the geofences can be automatically determined from remote monitoring data, such as satellite images, based on long-term differences and/or similarities between adjacent geographic units. In a third embodiment of the second variation, the geofences can be automatically determined based on other user accounts' geofences. However, the geofences can be otherwise determined. The geofencing module can be run or updated: once; every year (e.g., after crop harvest, after crop yield is determined, etc.); every time the method is performed; every time a new geofence is received from a user account; or at any other suitable frequency.

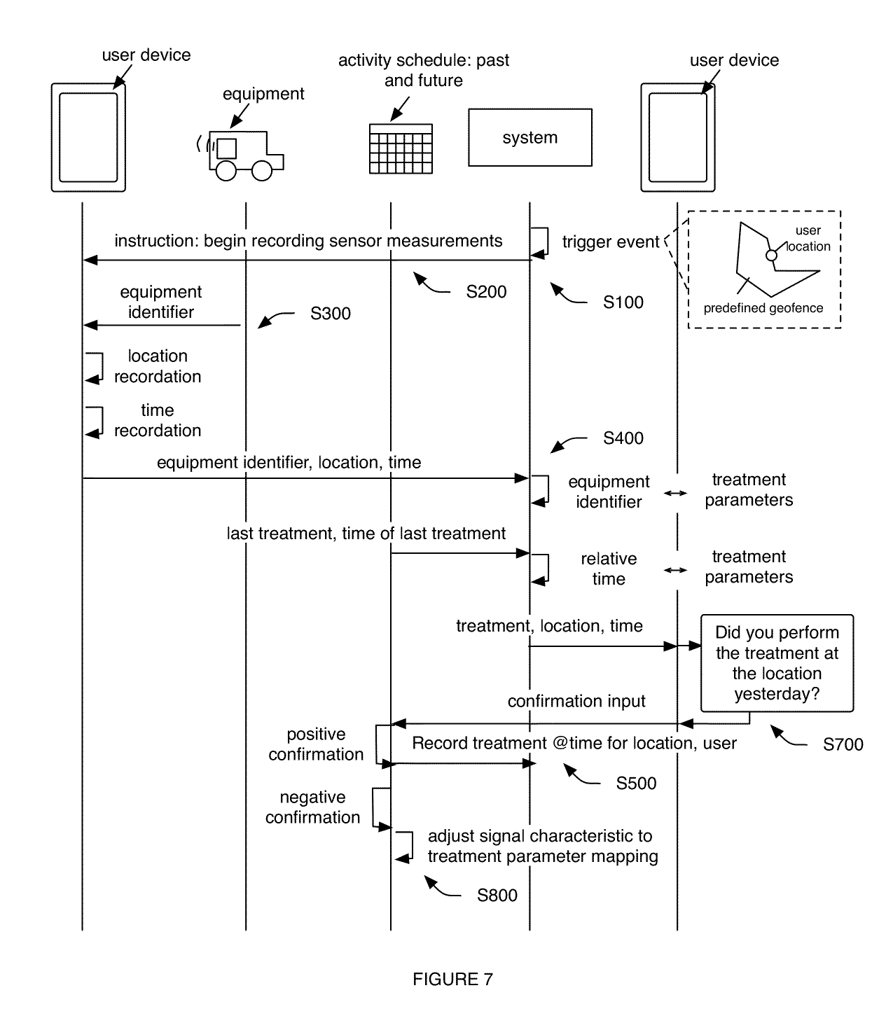

The method can additionally include a monitoring module that functions to monitor for the occurrence of a trigger event. The trigger event can be: user device proximity to a predefined geofence (e.g., a geofence associated with the user account associated with the user device, alternatively any other geofence, example shown in FIG. 7), user device power provision (e.g., determination of power provision to the user device, such as by turning on the agricultural equipment to which the user device is connected), or be any other suitable event indicative of agricultural treatment of a field. The monitoring module can additionally automatically trigger subsequent method performance in response to trigger event occurrence. For example, the monitoring module can control sensor measurement recordation (e.g., trigger or cease recordation), trigger native application functionality (e.g., turn on the native application, switch native application operation modes to a recordation mode or standby mode, etc.), or otherwise interact with the user device.

When the trigger event includes user device proximity to the predefined geofence, the monitoring module can receive a user device location and determine the user device proximity to the predefined geofence based on the user device location. The user device location can be measured (e.g., recorded) by: the user device (e.g., the location module of the user device), a third party (e.g., a cellular service provider, mobile device manufacturer, etc.), or by any other suitable system. The user device location can be a rough user device location (e.g., an estimated user device location with a large margin of error, such as a margin of error over 10 m), a high-precision user device location (e.g., a measured user device location with a small margin of error, such as precision within 10 m of the actual location), a set of time-stamped user device locations, or any other suitable set of user device locations. The user device location can be determined and/or received at a predetermined frequency, in response to user device proximity to a beacon (e.g., an i-beacon, a beacon connected to an agricultural device, etc.), or at any other suitable frequency. In a specific example, the monitoring module can receive an activity update from a third party, wherein the activity update can include a set of rough, time-stamped user device locations.

In a first variation, the monitoring module can monitor the user device location by: receiving a rough user device location in a passive monitoring state, determining user device proximity to a predefined geofence (e.g., wherein the estimated user device and/or margin of error overlap or falls within a predetermined distance of the geofence), prompting the user device for a high-precision location (e.g., by remotely launching the native application on the user device, controlling the native application to switch to a high-precision operating mode, etc.), remotely launching the sensor recordation in response to the high-precision location falling within the predefined geofence, and reverting to the passive monitoring state (e.g., ceasing high-precision location determination) in response to the high-precision location falling outside the predefined geofence. However, the monitoring module can monitor the user device location in any other suitable manner.

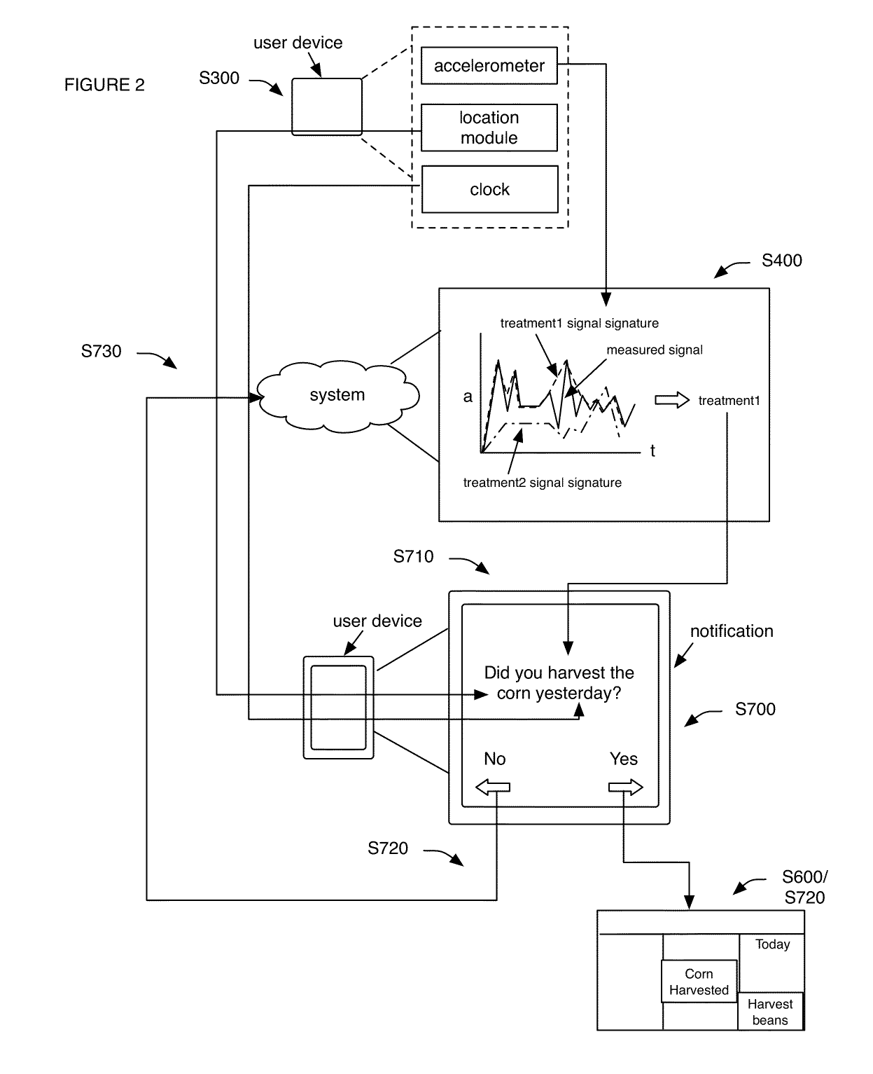

The monitoring module can additionally determine whether the user was performing an agricultural activity (e.g., on agricultural equipment) prior to prompting the user device for the high-precision location and/or remotely launching sensor recordation. In a first embodiment, the monitoring module can determine whether the user was performing an agricultural activity based on the set of time-stamped user device locations. For example, the user can be deemed to be performing the agricultural activity when the user device locations indicate that the user device was travelling at a speed exceeding a threshold speed and/or accelerating along the geographic region at an acceleration exceeding a threshold acceleration. In a second embodiment, the monitoring module can determine that the user was performing an agricultural activity based on auxiliary user device information received with the location data. For example, the auxiliary user device information can include user device accelerometer or gyroscope measurements. The user can be deemed to be performing the agricultural activity when the auxiliary user device information matches a predetermined measurement pattern (example shown in FIG. 2) or has a high probability of being agricultural activity (e.g., as determined by a treatment identification module). In a third embodiment, the monitoring module can determine that the user was performing an agricultural activity based on agricultural equipment location data, wherein the agricultural equipment can include a location module that transmits the equipment location, through a wired or wireless connection, to the monitoring module. For example, the user can be deemed to be performing the agricultural activity when the user device is collocated with the agricultural equipment location, moves at the same rate as the agricultural equipment, or is otherwise related to the agricultural equipment.

The system can additionally utilize a user device application that functions to perform functions local to the user device. The user device application can be a native application, web application, or be any other suitable application that runs on the user device. The user device application can: record sensor measurements, timestamp the sensor measurements, store the sensor measurements (e.g., temporarily cache, until the user device is connected to a high-bandwidth connection, etc.), transmit the sensor measurements to the remote computing system, store all or a portion of the modules, partially or entirely process the recorded sensor measurements, display notifications or queries on the user device, receive user inputs (e.g., responses) to the notifications or queries, or otherwise perform all or a portion of the method. The user device executing the user device application can be: the farmer's device, the service provider's device, the data logger, or any other suitable computing device.

### 2. System.

The method is preferably performed by a system. The system is preferably a remote computing system (e.g., a set of networked servers), but can alternatively be the user device, a secondary user device, agricultural equipment, such as a vehicle, an on-site device, or be any other suitable computing system. The servers can include one or more processors (e.g., CPU, GPU, microprocessor, etc.), memory (e.g., volatile memory, non-volatile memory, such as flash memory, etc.), communication module used to communicate with the user device(s) and/or other endpoints (e.g., WiFi transceiver, Zigbee transceiver, BLE transceiver, NFC transceiver, etc.), or include any other suitable computing component.

In a first variation, each server runs all modules, and manages the computation for one or more analysis zones, exclusive of other analysis zones (which are handled by other servers). The server can locally store or otherwise access only the data relevant to the analysis zone (e.g., crop stressor data, past yield data, etc.).

In a second variation, the set of servers function similar to the first variation, except that a cluster of servers is used instead of a single server. In a first sub-variant, each server within the cluster can specialize in a module, exclusive of the other modules. In a second sub-variant, the computation for all or a subset of the modules can be distributed across all servers.

In a third variation, the set of servers include a set of resource servers, user account servers, and analysis servers. These servers are preferably stateless, but can alternatively be stateful or have any other suitable characterization. The set of resource servers can store persistent data, such as historic yield data (e.g., WDRVI, LAI, and satellite images); weather data; soil data; nitrogen profiles for different fertilizer types; sensor measurement values; sensor measurement value signatures or treatment parameter value signatures for possible treatment types; or any other suitable global information or auxiliary information associated with the field identifier. The user account servers can store user account data, such as the geographic locations with which each user account (e.g., farmer) is associated (e.g., fields, geofences delineating the field boundaries, etc.); equipment available to the farmer (e.g., seeding equipment, nitrogen application equipment, other agricultural equipment etc.); crop cultivars yield goals; management data (e.g., planting date, treatment history, etc.); crop history; current crop parameters (e.g., as determined by the crop module); or any other suitable user-associated information. The user account data can be received from the user, be automatically determined (e.g., from secondary data received from the user or secondary sources, such as the satellite data), or be otherwise determined. The analysis servers can run the analysis modules, wherein the underlying data can be retrieved from the resource servers and/or user account servers. However, computation and storage can be distributed in any other suitable manner across a set of servers.

The method preferably leverages a user device, which functions to record the data indicative of agricultural treatment performance. The method is preferably performed by an application executing natively on the user device, but can alternatively be performed by a browser-based application or any other suitable application on the user device. The method can be performed offline or be performed only when connected to a communication channel (e.g., data connection). The user device can additionally function to record the location, time, speed, heading, or any other suitable parameter associated with the agricultural treatment. The user device can additionally function to output information to a user and/or receive information from a user. In a first variation, the user device can be a smartphone, tablet, laptop, wearable computing device, or any other suitable mobile device. In a second variation, the user device can be a data logger configured to removably or permanently connect to agricultural equipment. In a specific example, the data logger can connect to the communications bus (e.g., ISOBUS, CAN bus) of the agricultural equipment, and record intra-equipment communication. However, the user device can be any other suitable device.

The user device can include a set of sensors, a location module, a processor configured to process the sensor measurements, a communication module configured to communicate information to and from the user device, a user input (e.g., a touchscreen, keyboard, microphone, etc.), a user output (e.g., a display, speakers, vibration motor, etc.), and/or any other suitable component. The set of sensors can include an accelerometer, light sensor, sound sensor (e.g., microphone, etc.), or any other suitable sensor. The location module can include a GPS unit, a GNSS unit, a triangulation unit that triangulates the device location between mobile phone towers and public masts (e.g., assistive GPS), a Wi-Fi connection location unit, a WHOIS unit (e.g., performed on IP address or MAC address), a GSM/CDMA cell identifier, a self-reporting location information, or any other suitable location module. The communication module can be a long-range communication module, a short-range communication module, or any other suitable communication module. The communication module can facilitate wired or wireless communication. Examples of the communication module include a 802.11x, Wi-Fi, Wi-Max, NFC, RFID, Bluetooth, Bluetooth Low Energy, ZigBee, cellular telecommunications (e.g., 2G, 3G, 4G, LTE, etc.), radio (RF), wired connection (e.g., USB), or any other suitable communication module or combination thereof.

The user device can be associated with an identifier. The identifier can uniquely identify the user device, the user associated with the device (e.g., wherein the identifier can be a username, a user account login, etc.), the farm or entity associated with the device, or any other suitable object or entity. The identifier can be a serial number, a phone number, username, an account login, or any other suitable identifier. The identifier is preferably stored by the user device, and is preferably associated with the sensor measurement by the user device. However, the identifier can be otherwise used. The identifier is preferably associated with a set of information, which is preferably stored by the system but can alternatively be stored by the user device or any other suitable computing system or storage system. The set of information can include entity information (e.g., an entity name, location, number of fields, crops in each field, etc.), user information (e.g., user identity, user principal-agent relationship relative to the entity, etc.), scheduling information (e.g., future treatment information), historical treatment information, purchase information, billing information, or any other suitable information. The user device (or user device identifier) can be associated with a user account, multiple user accounts, no user accounts, the field identifier, or with any other suitable data structure. The user device can be associated with the data structures in the system, by the system, by the user, automatically based on the geographic locations, or be otherwise associated with the data structures. The user device can be dynamically or manually associated or disassociated with the data structures.

The method can additionally be used with a piece of agricultural equipment, but can alternatively be used with any other suitable piece of equipment. The agricultural equipment can include tractors, harvesting equipment (e.g., combines, corn pickers, headers, diggers, lifters, nut harvesters, etc.), hay or foraging equipment (e.g., bale accumulators, balers, forage harvesters, forage blowers, etc.), tilling equipment (e.g., plows, cultivators, tillers, etc.), planting equipment (e.g., seeders, markers, drills, planters, tenders), grain handling and storage equipment (e.g., wagons, drive over hoppers, etc.), sprayers and other applicators, livestock handling equipment, rotary cutters and shredders, or any other suitable equipment. The equipment is preferably mobile, and more preferably capable of translating along a portion of a crop field. However, the equipment can be substantially static.

The agricultural equipment can include a communication module, wherein the communication module can be passive or active. In one variation, the communication module is active and communicates agricultural equipment operation parameters, identifiers, and/or any other suitable set of data. In a second variation, the communication module is passive and communicates an identifier. The identifier is preferably an equipment identifier, wherein the equipment identifier can be associated with an entity (e.g., the owner of the equipment, the service provider providing the equipment) and/or treatment, but can alternatively be associated with any other suitable piece of information. The equipment identifier can uniquely identify the piece of equipment, identify the category that the equipment belongs to, identify the entity, or identify any other suitable piece of information. However, the identifier can identify any other suitable piece of information. The equipment identifier is preferably communicated to a user device, more preferably a user device within a threshold distance of the equipment (e.g., the user device of a user operating the equipment). Alternatively or additionally, the equipment identifier can be communicated to one or more beacon receivers statically mounted in the crop field. However, the equipment identifier can be communicated to any other suitable receiving device. In a third variation, the communication module is passive and functions as a trigger to launch the user device application. However, the communication module can have any other suitable functionality.

Examples of the communication module include a short-range transmitter (e.g., NFC, Bluetooth, CAN bus, beacon, etc.), long-range transmitter (e.g., WiFi, cellular transmitters), passive identifier (e.g., QC code, serial number, bar code, etc.), but any other suitable communication module can be used. The communication module can additionally or alternatively include a data receiver. The data receiver can be a short-range receiver (e.g., NFC, Bluetooth, CAN bus, etc.), long-range receiver (e.g., WiFi, cellular transmitters), but any other suitable communication module can be used. The equipment can include a set of sensors, a processor configured to process the set of sensors, a location module, or any other suitable component. The set of sensors can include any combination of the sensors discussed above, or be any other suitable sensor. The location module can be any location module discussed above, or be any other suitable location module.

### 3. Method.

As shown in FIG. 1, monitoring a user device parameter of a user device for a trigger event S100 and initiating sensor measurement recordation in response to occurrence of the trigger event S200 functions to determine when sensor measurements should be recorded, and/or when an agricultural treatment is being performed or will imminently be performed. This can be particularly useful in applications where communication resources and/or data storage on the user device is limited. The trigger event is preferably automatically monitored and detected, but can alternatively be otherwise monitored and/or detected. The sensor measurement recordation is preferably automatically initiated, but can alternatively be otherwise initiated. In a specific example of partial manual performance, the trigger event can be automatically detected, a notification can be sent to the user in response to trigger event detection, and the sensor measurement recordation initiated in response to user interaction with the notification (e.g., selection of a “record” icon on the notification). The trigger event is preferably monitored and detected by the same computing system (e.g., the remote server or the user device), but can alternatively be detected by separate and discrete computing systems. Trigger event detection and recordation initiation are preferably performed by the same computing system (e.g., the remote server or the user device), but can alternatively be detected by separate and discrete computing systems.

The user device parameter can be a user device geographic location, a user device acceleration (e.g., vibration or linear acceleration), the application state, the user account state, or any other suitable user device parameter. The trigger event can be user device entry into the field geographic boundaries, user initiation or activation of the application, detection of an identifier (e.g., the equipment identifier, field identifier, etc.), determination that a parameter of the recording device substantially meets or surpasses a parameter threshold (e.g., the motion of the recording device substantially matches a predetermined pattern), user device transition into an active mode (e.g., due to power provision), determination that the substantially instantaneous time is substantially similar to a previously scheduled treatment time for the field, determination that the substantially instantaneous location is substantially similar to the location of a field scheduled for treatment, determination that the instantaneous or average user device velocity or acceleration is within a predetermined velocity or acceleration range, determination that the instantaneous or average user device motion parameters substantially match a predetermined pattern, determination that the ambient light exceeds a light threshold indicative of being in the field, determination that the ambient sound falls below a sound threshold indicative of being in the field, or be any other suitable trigger event. For example, sensor measurement can be triggered in response to detection that the user device is vibrating above a threshold rate or vibrating at a predetermined pattern (e.g., substantially similar to the vibration pattern of riding on a piece of farm equipment). In another example, sensor measurement can be triggered in response to detection that the ambient sound substantially matches a predetermined audio pattern (e.g., of an operating piece of farm equipment). In another example, sensor measurement can be triggered in response to determination that the user device is collocated with or proximal to a predefined geofence associated with the user account. However, any other suitable trigger event can be detected and used to trigger sensor measurement recordation.

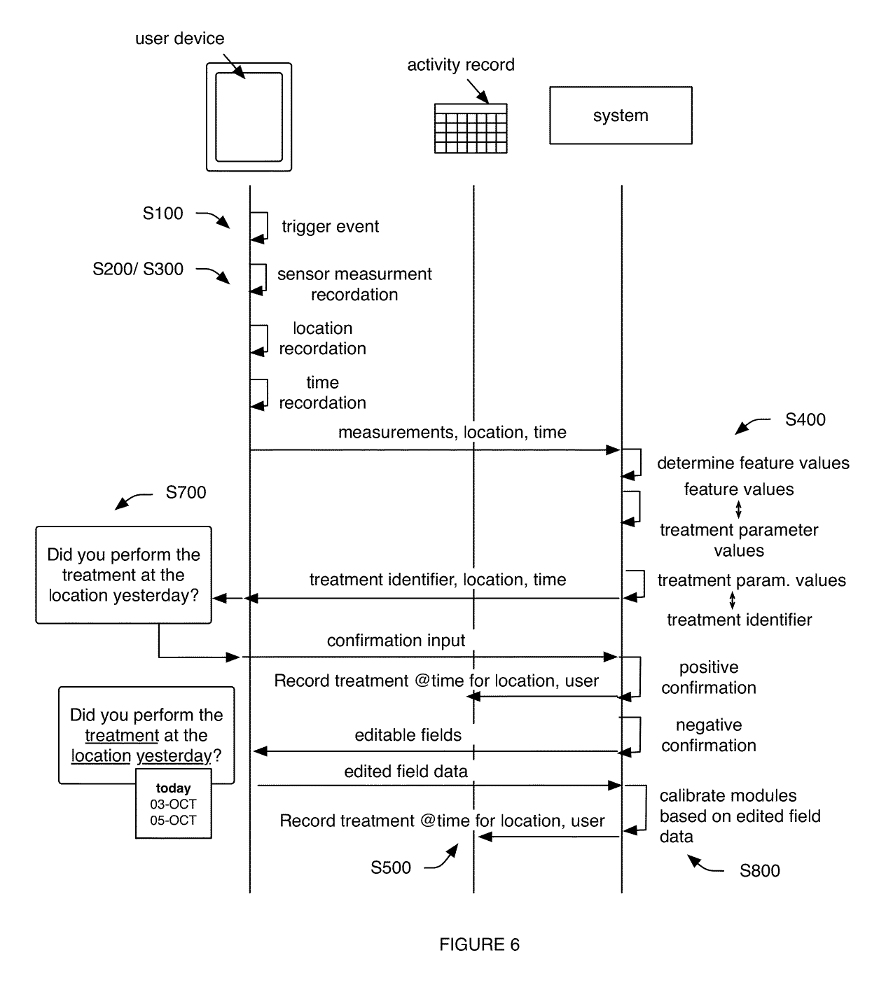

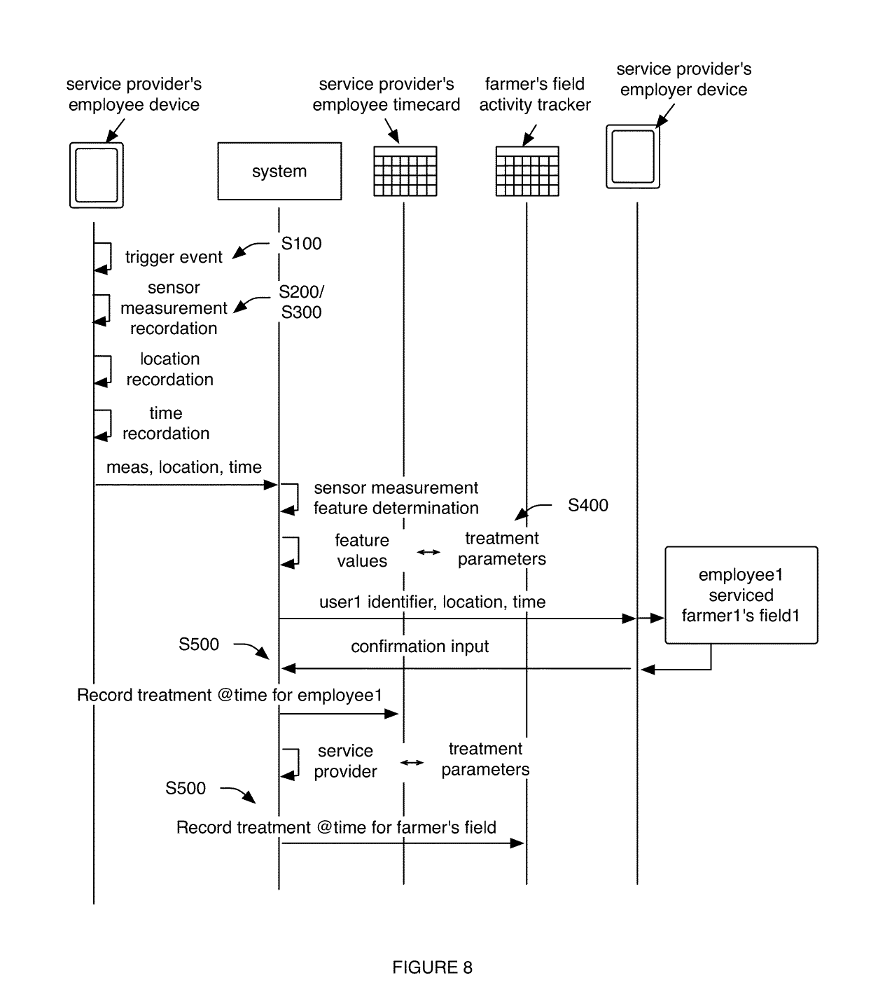

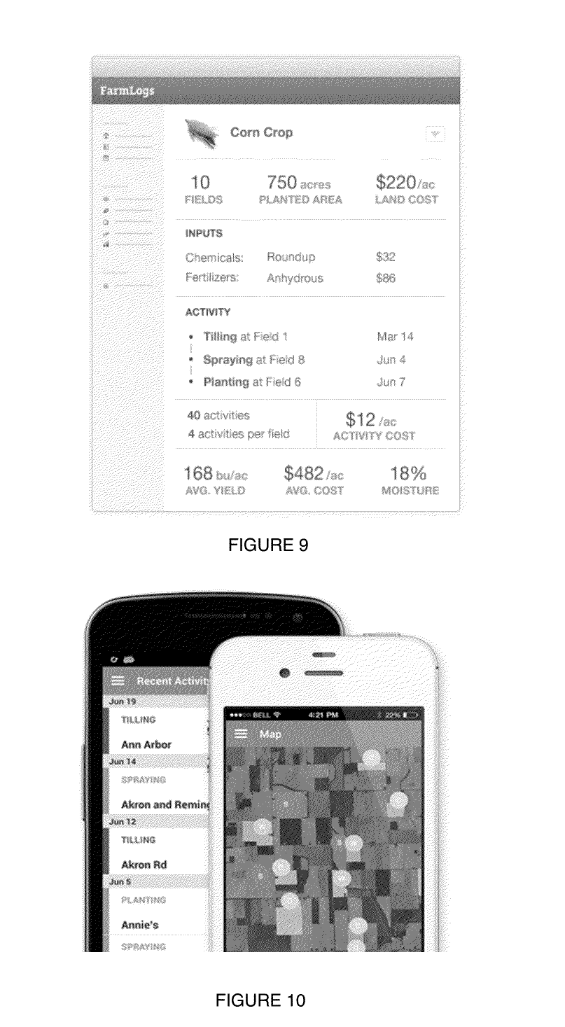

Initiating sensor measurement preferably includes triggering sensor measurement at the user device, but sensor measurement can be otherwise initiated. In a first variation, the trigger event is remotely monitored at a remote computing system. In response to trigger event occurrence, the remote computing system can automatically remotely launch the application on the user device and instruct the application to begin recording sensor measurements, example shown in FIG. 7. In a second variation, the trigger event is remotely monitored at a remote computing system. In response to trigger event occurrence, the remote computing system can automatically generate and present a notification to the user (e.g., “Are you in field 1?,” “Are you seeding field 1?”) based on the data used to detect the trigger event and/or other contextual data, such as the time of the year or a crop plan for the field. Sensor measurement recordation can be initiated in response to a positive user input (e.g., selection of a “yes” icon). In a third variation, the trigger event is locally monitored at the user device (examples shown in FIGS. 6 and 8), wherein the user device (e.g., the application or the firmware) automatically initiates sensor measurements in response to occurrence of the trigger event. However, the sensor measurements can be otherwise initiated.

Recording a set of sensor measurements over a treatment time period S300 functions to record a set of data as the treatment is being performed, wherein the performed treatment can be identified based on the recorded data. The data, or a combination thereof, can be used to identify a specific treatment, a treatment category, or any other suitable treatment parameter. The data can include sensor data, data received from the user (e.g., cultivar inputs, field inputs, treatment inputs, etc.), device use information (e.g., patterns of user device activation), application use information (e.g., patterns of application use, functions of each application used, etc.), crop plan information for the field (e.g., a schedule of planned treatments for the field, a schedule of previously performed treatments for the field, etc.), or any other suitable data. Examples of the sensor measurement can include acceleration, velocity, other orientation sensor measurements, light, sound, images, a location identifier (e.g., measured by the location module, communicated by a beacon or other transmitter arranged within the crop field, etc.), power parameter values, equipment status, equipment flow rate, or any other suitable sensor measurement. The sensor measurements are preferably time stamped by the user device, but can alternatively be otherwise processed or remain unprocessed. The timestamp is preferably the time of sensor measurement recordation, but can alternatively be the time that the sensor measurement indicative of a treatment was detected, or be any other suitable time. Each sensor measurement can additionally be associated with a geographic location. The location is preferably the geographical location at which the sensor measurement was recorded (e.g., geographical location at which the recording system was located when the recording system recorded the sensor measurement), but can alternatively be any other suitable location. However, the sensor measurements can be associated with any other suitable set of metadata. The sensor measurement is preferably recorded prior to sensor measurement analysis and treatment determination, but can alternatively be performed concurrently with sensor measurement analysis or performed at any other suitable time.

The sensor measurement can be recorded or measured by a sensor, a user device, the equipment, a receiver, the remote computing system, or any other suitable sensor measurement recordation mechanism. When the sensor measurement is recorded by the agricultural equipment, the sensor measurement is preferably received by the user device from the equipment (e.g., over a wireless connection or through a wired connection, such as the ISO bus) and recorded by the user device. However, the sensor measurement can be recorded by any other suitable computing system. However, the sensor measurements can be otherwise stored and/or transmitted.

The treatment time period can be the entire treatment duration (e.g., from treatment initiation to treatment cessation), a portion of the treatment duration (e.g., 15 minutes of a 3-hour treatment session), or be any other suitable time period during the treatment duration. The treatment time period is preferably associated with one or more timestamps, such as a start timestamp, an end timestamp, and one or more intervening timestamps between the start and end timestamps. The timestamps are preferably unique (e.g., UTC timestamps, including a date and hour of day), but can alternatively be relative to a start time, or be any other suitable timestamp. The sensor measurements can be recorded at a predetermined frequency after the trigger event is met, but can alternatively be recorded sporadically after the trigger event is met, recorded once after the trigger event is met, recorded continuously after the trigger event is met until an end event is met (e.g., wherein the end event can be cessation of the trigger event sensor measurement pattern, etc.), or be recorded at any other suitable frequency.

When the treatment time period is less than the full treatment duration, the method can include automatically determining the full treatment duration. In a first variation, automatically determining the full treatment duration can include: identifying a planned treatment corresponding to the recorded treatment (e.g., overlapping the treatment time, within a time threshold of the treatment time, having a similar or same treatment identifier, or sharing any other suitable treatment parameter values) and assigning the scheduled treatment duration as the actual treatment duration. In a second variation, automatically determining the full treatment duration can include: periodically measuring a subset of the set of sensor measurements at a higher frequency than the remainder of the sensor measurement set, and estimating the full treatment duration based on the subset of sensor measurements. For example, the method can include measuring the geographic location more frequently than accelerometer data, estimating that the treatment began when the geographic location began changing faster than a first rate, and estimating that the treatment stopped when the geographic location began changing slower than a second rate, wherein the second rate can be the same as, faster, or slower than the first rate, and the treatment duration extends between the time when treatment began and the time when treatment ceased. In a third variation, the full treatment duration can be selected from a chart or graph, based on the treatment identifier (e.g., wherein all spraying treatments take the same amount of time). In a fourth variation, the full treatment duration can be calculated based on geographic parameter values of the field. For example, the full treatment duration can be calculated based on a known treatment rate (e.g., average treatment rate across the population, mean treatment rate, user-specified treatment rate, etc.) and the size of the crop field (e.g., the size of the geographic region enclosed by the predefined geofence). However, the full treatment duration can be otherwise estimated, calculated, selected, or otherwise determined.

Recording the sensor measurement can additionally include recording or determining auxiliary information, which functions to contextualize the sensor measurement, examples of which are shown in FIGS. 3-7. The treatment parameters and auxiliary information can be cooperatively used to determine with whom the treatment information should be stored (e.g., which user should be requested to confirm the treatment), which plot of land the treatment should be associated with, the particular crop the treatment should be associated with, when the treatment was performed, or determine any other suitable relationship between the treatment and the user account. The auxiliary information is preferably recorded concurrently with sensor measurement recordation, but can alternatively be recorded in response to occurrence of the trigger event, recorded when the sensor measurement is transmitted to the system, or recorded at any other suitable time. The auxiliary information is preferably recorded by the computing system mechanically supporting the sensor measurement recordation mechanism, but can alternatively be recorded by a secondary computing system. Examples of auxiliary information include an equipment identifier, an equipment accessory identifier (e.g., a fertilizer container identifier, a seeding attachment identifier, etc.), the entity performing the treatment, and/or any other suitable auxiliary information.

Recording the sensor measurement can additionally include transmitting the sensor measurements, auxiliary information, and/or any other suitable information to a remote computing system. The sensor measurements can be transmitted to the remote computing system as they are recorded (e.g., transmitted in near real-time), shortly after they are recorded (e.g., wherein the sensor measurements can be temporarily cached), after the treatment session, upon connection with a communication channel (e.g., wired or wireless), upon connection with a high-bandwidth or low-latency communications channel (e.g., a WiFi channel), upon prompting by the user, or be transmitted at any other suitable time. The sensor measurements can be transmitted wirelessly or through a wired connection. The sensor measurements are preferably automatically transmitted, but can alternatively be transmitted in response to receipt of a user input. The sensor measurements can be transmitted as: raw values, metadata-tagged values, processed values (e.g., wherein the sensor measurements can be processed into feature values at the user device, wherein the feature values are transmitted), or be transmitted in any other suitable form. Alternatively, the method can be performed locally at the user device, wherein the sensor measurements and modules can be locally stored at the user device. In a first variation, the user device records the sensor measurements in the field, stores the sensor measurements until the user device connects to a communication connection, more preferably a high-bandwidth communication connection (e.g., a WiFi connection) but alternatively any other suitable connection, and uploads the sensor measurements to the remote computing system using the high-bandwidth communication connection. In a second variation, the user device can transmit the sensor measurements to the remote computing system in real- or near-real time (e.g., stream the sensor measurements as they are being recorded or after a short caching duration). In a third variation, the sensor measurements can be stored and processed on the user device.

Identifying a past agricultural treatment based on the sensor measurements S400 functions to identify the agricultural treatment (recorded treatment) using features of the sensor measurements. The past agricultural treatment can be identified by the treatment parameter determination module, treatment identification module, a combination of the above, or by any other suitable module. The past agricultural treatment can be identified by the remote computing system, the user device, or any other suitable device. Identifying a past agricultural treatment based on the sensor measurements can include: analyzing the set of sensor measurements to determine values for a set of sensor measurement features, and analyzing the sensor measurement feature values to determine values for a set of treatment parameters, and identifying the treatment based on the treatment parameter values. However, the past agricultural treatment can be otherwise identified. The sensor measurement feature values and treatment parameter values are preferably determined by the treatment parameter determination module, but can alternatively be determined in any other suitable manner. The treatment is preferably identified by the treatment identification module, but can alternatively be determined in any other suitable manner. The sensor measurement feature values, treatment parameter values, and/or treatment identity can be determined based on the set of sensor measurements, auxiliary information, auxiliary information associated with the crop field, or based on any other suitable information. The past agricultural treatment is preferably identified using machine learning techniques (e.g., decision tree learning, association rule learning, artificial neural networks, inductive logic programming, support vector machines, clustering, Baysean networks, reinforcement learning, representation learning, similarity and metric learning, sparse dictionary learning, random forest learning, etc.) either supervised or unsupervised, but can alternatively be empirically determined, manually assigned, or otherwise determined.

In a first variation, identifying a past agricultural treatment includes: determining a probability for each of a set of possible treatment types; selecting a possible treatment type from the set having a high probability as the past agricultural treatment, wherein the possible treatment type is associated with a treatment identifier; and assigning the treatment identifier as the identifier for the past agricultural treatment. The probability for each of the set of possible treatment types is preferably determined by the treatment identification module for the respective possible treatment type, but can alternatively be determined by another module. The probability for each of the set of possible treatment types can be determined based on the set of sensor measurements, a treatment time associated with the treatment time period, the auxiliary information associated with the field identifier, or any other information. In one example, the probability of the recorded treatment being a seeding event for a field can be higher than the probability of the recorded treatment being a fertilizing event based on the auxiliary information that soybeans were to be planted on the field, and that the treatment time is relatively late in the corn growing season. In a second example, the probability of the recorded treatment being a seeding event for a field can be higher than the probability of the recorded treatment being a fertilizing event, based on the auxiliary information that the crop plan for the field included a seeding event during the treatment time. However, the probability can be otherwise determined.

In a second variation, identifying a past agricultural treatment includes matching the sensor measurement features or a combination thereof to a predetermined set of sensor measurement feature values and/or a set of treatment parameter values associated with each possible treatment of the set (examples of which are shown in FIG. 4 and FIG. 6). The recorded treatment can be identified as the possible treatment type having the best sensor measurement feature value and/or treatment parameter value match.

In a first example, a harvesting action can be identified in response to detection of an acceleration pattern indicative of traversal through a field (e.g., in contrast to traversal along a road) and an equipment identifier indicative of a harvester. In a second example, a first acceleration pattern can be identified as a spray treatment, while a second acceleration pattern different from the first can be identified as a planting action (e.g., seed application treatment). In a third example, the same acceleration pattern can be associated with a first and second treatment, wherein the acceleration pattern in combination with a first ambient light pattern (e.g., a constant light intensity) can identify the first treatment, and the acceleration pattern in combination with a second ambient light pattern (e.g., a dappled or highly variant light intensity) can identify the second treatment. In a fourth example, a velocity pattern can be associated with a specific user, wherein the specific user is associated with a treatment or action (e.g., wherein the user is an employee of a spraying service provider). In a fifth example, a first treatment can be identified in response to detection of a first CAN bus sensor measurement pattern, and a second treatment can be identified in response to detection of a first CAN bus sensor measurement pattern different from the first CAN bus pattern. However, the treatment can be otherwise determined based on the set of sensor measurements.

In a third variation, identifying a past agricultural treatment includes querying the user for an agricultural treatment identifier and receiving the identifier from the user device or user account.

In a fourth variation, as shown in FIG. 7, the recorded treatment identifier can be inferred based on the auxiliary data. In one example, the recorded treatment identifier can be inferred based on the proximity to and the type of the last treatment that was performed on the geographic location, wherein the recorded treatment type typically (e.g., statistically) follows the prior treatment type. In a second example, the recorded treatment identifier can be inferred based on a change in a parameter of previously purchased inventory, such as a change in the weight of fertilizer, wherein a treatment type statistically associated with the changed inventory is inferred. In a third example, the treatment time can be compared to weather data to infer the treatment, wherein certain treatments are statistically performed (e.g., based on population data) within a predetermined period of time after a weather event. In this example, the fact that a treatment was performed can be determined based on the set of sensor measurements. In a specific example, a first treatment can be determined when it is performed right after a heavy rain, and a second treatment can be determined when it is performed during a dry spell. In a fourth example, the treatment can be determined based on the treatment time, treatment location, and a predetermined treatment schedule, wherein the determined treatment type can be the treatment listed in the schedule substantially proximal or equal to the treatment time for the field encompassing the treatment location. In a fifth example, the treatment can be determined based on a translation path of the recording device (e.g., as recorded by the location module), wherein different treatments are associated with different translation paths. In a sixth example, the treatment can be determined based on differences between a first and second remote measurement taken at different times. In a specific example, the treatment that was applied to a plant can be determined based on a first and second growth stage recorded before and after treatment application. In a second specific example, the treatment that was applied to the plant can be determined based on remotely measured soil moisture levels, before and after the treatment. In a seventh example, the equipment identifier can be associated with a treatment, as shown in FIG. 7. However, the treatment can be otherwise determined based on the auxiliary data. However, the past agricultural treatment can be identified in any other suitable manner.

The treatment parameter values to be associated with a user account can additionally be determined based on third-party data. In a first example, a treatment can be recorded for a farmer in response to determination that a service provider has treated the farmer's field. The determination that the service provider has treated the farmer's field can be based on recordation of the treatment sensor measurement characteristic at a geographic location corresponding to the farmer's field by a user device associated with the service provider, based on confirmation by the service provider (or service provider employee) that the treatment has been performed, or determined in any other suitable manner. In this example, the system can receive information from both entities, wherein the service provider is incentivized to use the system for scheduling, planning, billing, and payroll purposes, while the farmer is incentivized to use the system for scheduling, tracking, billing, and planning purposes. In a second example, a treatment can be determined based on a set of sensor measurements recorded by a farmer device (e.g., a farmer's smartphone), wherein the sensor measurements can include an equipment identifier. A supplier account that is associated with the equipment identifier can be updated with the farmer's billing information and/or use information in response to treatment confirmation by the farmer.

Generating a record of the past agricultural treatment S500 functions to automatically log the past agricultural treatment. In particular, this functions to provide a record of the past treatment, wherein the record can be used to automatically: populate an empty treatment timeslot in the crop plan for the field, verify the scheduled treatment for the timeslot, refine the parameters for the scheduled treatment, otherwise automatically populate or update the crop plan, notify the user as that the treatment has occurred, or be otherwise used. The record can be generated by the remote computing system, the user device, or by any other suitable system. The record preferably includes the treatment time period, an identifier for the past agricultural treatment (e.g., treatment type), and a field identifier for the predefined geofence, but can additionally or alternatively include other treatment parameters, such as an identifier for treatment-performing entity, the brand or type of treatment used, or the agricultural equipment used, or include any other suitable information. The record is preferably generated after the treatment has been identified, but can alternatively be generated after the treatment identifier (e.g., treatment type) has been verified or validated (e.g., automatically generated based on the confirmation input), or be generated at any other suitable time. The record is preferably generated based on automatically-determined information, but can alternatively be generated entirely or partially based on manually-entered information (e.g., information received from the user) or based on any other suitable set of information. The record is preferably stored in association with a user account or user identifier, but can alternatively or additionally be stored in association with the field identifier, or be stored in any other suitable manner. The user account is preferably for a user controlling the field encompassing the treatment location (e.g., the farmer, farmer employee, etc.), but can alternatively be for a user that controls the farm equipment (e.g., supplier, supplier employee, etc.), or be any other suitable user.

The method can additionally include populating a crop plan based on the record Shoo, which functions to update or generate a treatment schedule associated with the field identifier after the treatment has been identified. The crop plan can be populated: after treatment has been identified (e.g., in response to treatment identification), after treatment identification by the user (e.g., in response to treatment validation by the user, in response to receipt of the confirmation input), and/or at any other suitable time. In a specific example, the crop plan can be populated with the treatment parameter values after automatic determination, then updated with corrected treatment parameter values after treatment validation by the user. However, the crop plan can be updated in any suitable order. The crop plan is preferably automatically populated by the system (e.g., by the user device, the remote system, etc.), but can alternatively be manually populated by the user or be otherwise populated. The crop plan can be populated by the remote computing system, the user device, or by any other suitable system.

The crop plan is preferably a schedule of treatments associated with the field identifier (example shown in FIG. 12), but can alternatively be any other suitable record of treatments associated with the field identifier, user account (example shown in FIG. 14), or any other suitable data structure. The crop plan can be a record of past treatments only, a record of planned (e.g., future) treatments only, a record of past, present, and planned treatments, or any other suitable set of treatments. Each crop plan is preferably associated with only the field identifier, but can alternatively be associated with multiple field identifiers, a user account, and/or any other suitable information directly or indirectly related to the field identifier. The crop plan can include: the treatment time (e.g., date and/or hour of the treatment), the type of treatment (e.g., treatment identifier), the entity to perform the treatment, the agricultural equipment to perform the treatment, the type of treatment material to be used, the amount of treatment material to be used, the rate of treatment material application to the field, or include any other suitable set of treatment parameters.

In a first variation, automatically populating the crop plan can include adding the generated treatment record to an empty timeslot in the crop plan, wherein the empty time block (e.g., timeslot) corresponds to a treatment time of associated with the treatment time period. The crop plan preferably lacked a scheduled agricultural treatment for the empty time block prior to record addition, but can alternatively already include a scheduled agricultural treatment during all or a portion of the empty time block. The treatment time is preferably the treatment time period (e.g., wherein the empty timeslot corresponds to a time block extending from a treatment start time to a treatment end time), but can alternatively be a timestamp occurring during the treatment time period, a time block extending from (e.g., before or after) a timestamp occurring during the treatment time period, a timestamp within a threshold time duration from the treatment time period (e.g., within 15 minutes or hour of the treatment time period), or be any other suitable timestamp or set thereof. This variation can be particularly useful to fill in a record of past treatments or to update a record of past and present treatments, wherein the recorded treatment was not scheduled for the treatment time. However, this variation can be otherwise used.

In a second variation, automatically populating the crop plan can include updating a preexisting treatment record with the treatment parameters of the record. The preexisting treatment record can be a planned treatment (e.g., automatically generated treatment recommendation, manually entered planned treatment, etc.), past treatment (e.g., automatically generated past treatment, manually entered past treatment, etc.), or be any other suitable treatment record. Updating a preexisting treatment record can include: updating the record with the actual treatment time (e.g., shifting the treatment to the actual starting time), actual time period (e.g., adjusting the treatment time period to reflect the actual treatment time period), actual amount of treatment material used, actual treatment material application rate, actual entity that performed the treatment, actual portion of the field that was treated, or otherwise updating the preexisting treatment record.

In a third variation, the preexisting treatment record can be overwritten with the newly generated treatment record. This can occur: when the preexisting treatment record substantially matches the newly generated treatment record (e.g., has matching treatment identifiers, time period, timestamps, or other treatment parameter values); automatically, irrespective of treatment parameter value similarities; or when any other suitable set of conditions are met. However, the crop plan can be otherwise populated with the record.

The method can additionally include validating the treatment record S700, which functions to verify that the automatically determined treatment parameter values of the recorded treatment were correct (examples shown in FIGS. 2 and 6-8). The treatment record validation can be facilitated by the remote computing system, the user device, a combination of the above, or by any other suitable system. The treatment record information is preferably validated by the user (e.g., the farmer), but can alternatively be validated by the treating entity (e.g., the entity performing the treatment), a third party, automatically validated (e.g., with subsequently received data about the field, such as vegetative index data or subsequent treatment data), or be otherwise validated. When the treatment record is validated by a user, the treatment record can be presented at a user device (e.g., the recording device or a different user device associated with the user account), wherein the user device or secondary device can receive a confirmation input in response to the treatment record. The confirmation input can be a positive input (e.g., confirmation that the automatically determined treatment parameter values is correct) or negative input (e.g., an explicit or implicit indication that the determined treatment parameter values were wrong). However, the treatment record can be otherwise validated.

In a first variation, validating the treatment record can include passively validating the treatment. In a specific variation, passively validating the treatment record can include automatically populating the crop plan with the generated treatment record, presenting the updated crop plan to the user in response to a user request to view the crop plan, receiving a confirmation input associated with the record (e.g., receiving a record update, such as a second or new treatment identifier for the treatment), and correcting the crop plan based on the confirmation input.

In a second variation, validating the treatment record can include actively validating the treatment. In a specific variation, actively validating the treatment record can include: sending a query, including treatment parameter values, to a user device S710; receiving a confirmation input from the user account in response to the query S720; and validating the treatment record based on the confirmation input S730.

Sending the query to the user device S710 functions to facilitate easy treatment recordation by the user. The query (e.g., notification) can be displayed, read, or otherwise presented to the user at the user device. The query preferably includes one or more values of the set of treatment parameters, but can alternatively include any other suitable piece of information. In one variation, the query includes the determined treatment type, treatment time, and treated field, and can additionally include the treating entity or treating user. The query can be phrased as a question, or be phrased in any other suitable manner. The query is preferably a textual notification, but can alternatively or additionally include images (e.g., icons representative of the field, treatment, entity, etc.), videos (e.g., of the treatment itself), audio, or any other suitable type of content. The query preferably enables user input (e.g., input of one or more confirmation inputs), but can alternatively or additionally provide a link to a secondary interface (e.g., a URI), lack user input options, or enable any other suitable set of user interactions with the query or lack thereof. The query can be presented only when the native application is running, presented irrespective of native application execution (e.g., automatically triggered), or presented at any other suitable time.

Receiving a confirmation input from the user account S720 functions to receive an indication as to the accuracy of the automatically determined treatment parameter values. The confirmation input is preferably received from the user device presenting the query, but can alternatively be received from any other suitable device. The confirmation input is preferably received in response to the query, but can alternatively be received in response to record presentation to the user (e.g., as part of the crop plan), or be received at any other suitable time. The confirmation input can be explicit (e.g., user inputs) or implicit (e.g., lack of a user input). The user input can be a binary selection, a multivariable selection, a freeform entry, or any other suitable data entry. In one variation, the user can edit the presented treatment by entering in a new treatment or selecting a new treatment from a menu (e.g., as the confirmation input). The treatment parameter values can be editable as presented, or be rendered editable in response to receipt of the rejection input. The enabled user input can be a user gesture (e.g., a right/left motion, an up/down motion, etc.), text entry, audio entry, macro entry (e.g., wherein shaking the user device functions as an input), image entry, optical entry, or any other suitable entry type.

Validating the treatment record based on the confirmation input S730 functions to verify whether the automatically determined treatment parameter values were correct, and if not, determine a second treatment parameter value in lieu of the automatically determined treatment parameter value. Validating the treatment record can include receiving a positive confirmation input and receiving a negative confirmation input. The confirmation input can additionally be fed into the treatment parameter value determination module and/or treatment identification module to reinforce the selected treatment for the identified sensor measurement characteristic for subsequent treatment inferences.

Receiving a positive confirmation input from the user account functions to indicate that the determined treatment parameter values were correct. Positive confirmation inputs can include: receiving a user selection of an icon mapped to a positive confirmation input (e.g., selection of a “yes” icon); treatment parameter value presentation to the user followed by a lack of user edits or negative confirmation inputs (e.g., wherein the treatment parameter values are left alone by the user); or include any other suitable positive treatment parameter. In response to receipt of the positive confirmation input, the treatment parameter values preferably remain unedited, but can alternatively be otherwise adjusted.

Receiving a negative confirmation input from the user account functions to indicate that the determined treatment parameter values were incorrect, but can additionally or alternatively indicate any other suitable categorization of the treatment. Negative confirmation inputs can include: receiving a user selection of an icon mapped to a negative confirmation input (e.g., selection of a “no” icon); receipt of a treatment parameter value user edit (e.g., the user edits a treatment parameter value, such as the treatment identifier or treatment type, treatment time, field identifier, etc.); or include any other suitable negative treatment parameter.

In response to receipt of the negative confirmation input, a second treatment parameter value for the treatment parameter can be selected. The second treatment parameter value can then be presented to the user, be automatically stored as part of the treatment record, or otherwise used. In a first variation, the next best treatment (e.g., next best match or treatment type with the next highest probability) can be selected as the new determined treatment. In a second variation, the set of sensor measurements can be newly analyzed to determine a different set of sensor measurement features that can be used to select a different treatment. In a third variation, the treatment parameter value received from the user can be stored as the value for the respective treatment parameter in the treatment record. However, a negative confirmation input can be otherwise received, and the received user input can be otherwise used.

In a first example of actively validating the treatment record, the query can present user entry regions (e.g., icons for selection), wherein user selection of a first entry region (e.g., “yes”) can map to a positive confirmation input, while user selection of a second entry region (e.g., “no”) can map to a negative confirmation input. In a second example of actively validating the treatment record, the interface presenting the treatment record can provide user entry regions (e.g., icons for selection, text entry regions, editable text, etc.), wherein user selection of a first entry region (e.g., “yes”) can map to a positive confirmation input, while user input entry into a second entry region (e.g., text entry into a text field, editing a treatment parameter value, etc.) can map as a negative confirmation input.

The method can additionally include calibrating the modules based on the confirmation input S800, which functions to train the modules, using the confirmation inputs as ground truth. Because the farmers are motivated to keep accurate records (e.g., for subsequent treatment recommendation during the growing season, treatment efficacy analysis after the crops have been harvested, etc.), user-reviewed treatment records can function as substantially reliable ground truth data. These user-reviewed treatment records can be additionally verified against third party data (e.g., matching the treatment parameter values with auxiliary data). For example, the estimated amount of fertilizer applied to the field can be compared against the amount of fertilizer purchased or left in the fertilizer container to determine whether the user-entered or user-verified value was actually correct. The modules to be calibrated can include the treatment parameter determination module, the treatment identification module, or any other suitable module. The calibrated modules are preferably subsequently used to determine the treatment parameter values for subsequent treatments, but can be otherwise used. The calibrated modules can be used for the same user account, related user accounts (e.g., user accounts associated with fields within a predetermined geographic proximity of each other), all user accounts, treatments sharing a common parameter value (e.g., known or determined within a threshold confidence level, such as treatments using a particular combine), all treatments, or any other suitable population or subset thereof. The modules can be calibrated by the remote computing system, the user device, a combination of the above, or by any other suitable system. The updated modules are preferably transmitted and/or stored by the system performing the treatment parameter determination and/or treatment identification, but can alternatively be transmitted and/or stored by any other suitable system.

Calibrating the modules based on a positive confirmation input can include reinforcing the values, factor choices, or other module parameters used to determine the treatment parameter values. For example, the confidence value for the module constants, factor choices, or other module parameter values can be increased in response to receipt of a positive confirmation input in association with the treatment record. However, the modules can be otherwise reinforced in response to receipt of the positive confirmation input.

Calibrating the modules based on the negative confirmation input can include updating the modules (e.g., updating the models within the modules). In a first variation, updating the modules can include decreasing the confidence values for the module constants, factor choices, or other module parameter values. In a second variation, updating the modules can include determining a corrected value for the treatment parameter and iterating through different permutations of computational models, module constants, factor choices, or other module parameter values until the determined treatment parameter value, determined based on the respective sensor measurements, substantially matches (e.g., matches or matches within a margin of error) the corrected value and/or past correct values. Determining the corrected value for the treatment parameter can include: automatically determining a second treatment parameter value, presenting the second treatment parameter value to the user, and receiving a positive confirmation input from the user, wherein the second treatment parameter value is treated as the corrected value. Alternatively, determining the corrected value for the treatment parameter can include receiving the corrected treatment parameter value from the user. However, the corrected value for the treatment parameter can be otherwise determined.

An alternative embodiment preferably implements the above methods in a computer-readable medium storing computer-readable instructions. The instructions are preferably executed by computer-executable components preferably integrated with an agricultural action determination system. The agricultural action determination system can include a sensor measurement recordation system and a sensor measurement-to-action mapping system. The computer-readable medium may be stored on any suitable computer readable media such as RAMs, ROMs, flash memory, EEPROMs, optical devices (CD or DVD), hard drives, floppy drives, or any suitable device. The computer-executable component is preferably a processor but the instructions may alternatively or additionally be executed by any suitable dedicated hardware device.

Although omitted for conciseness, the preferred embodiments include every combination and permutation of the various system components and the various method processes.

As a person skilled in the art will recognize from the previous detailed description and from the figures and claims, modifications and changes can be made to the preferred embodiments of the invention without departing from the scope of this invention defined in the following claims.

We claim:

1. A method for autonomous crop plan population with past agricultural treatments, comprising:
monitoring a user device location for a user device at a remote computing system, wherein the user device is associated with a user account;
in response to the user device location falling within a predefined geofence associated with a field identifier and the user account, automatically recording a set of sensor measurements indicative of an agricultural treatment at the user device during a treatment time period, wherein the user device is located within the predefined geofence during the treatment time period;
automatically determining a first treatment identifier for the past agricultural treatment based on the set of sensor measurements at the remote computing system; and
automatically populating an empty timeslot in a crop plan for the field identifier with the first treatment identifier, wherein the empty timeslot corresponds to the treatment time period.

2. The method of claim 1, further comprising:
automatically sending a query to the user device, the query comprising the first treatment identifier;
receiving a confirmation input from the user device in response to the query;
wherein the empty timeslot is populated with the first treatment identifier in response to the confirmation input comprising a positive response; and
in response to the confirmation input comprising a second treatment identifier, automatically populating the empty timeslot with the second treatment identifier.

3. The method of claim 2, further comprising:
calibrating a treatment identification model, used to determine the first treatment identifier, based on the second treatment identifier and the set of sensor measurements for the agricultural treatment; and
automatically determining a third treatment identifier for a second agricultural treatment, based on a second set of sensor measurements recorded during a second treatment time period, using the calibrated treatment identification model.

4. The method of claim 3, further comprising: updating an existing treatment entry for a second timeslot corresponding to the second treatment time period within the crop plan with the third treatment identifier.

5. A method for autonomous record population with past agricultural treatments, comprising:
monitoring a user device parameter of a user device for a trigger event, wherein the user device is associated with a user account;
automatically initiating sensor measurement recordation in response to occurrence of the trigger event;
recording a set of sensor measurements over a treatment time period;
automatically identifying a past agricultural treatment based on the sensor measurements; and
automatically generating a record of the past agricultural treatment for the user account, the record comprising: the treatment time period, an identifier for the past agricultural treatment, and a field identifier for the predefined geofence.

6. The method of claim 5, wherein the user device parameter comprises a user device location, wherein the trigger event comprises the user device location falling within a predefined geofence associated with the user account, wherein the user device is located within the predefined geofence during the treatment time period.

7. The method of claim 6, wherein automatically identifying the past agricultural treatment based on the sensor measurements comprises determining a first identifier for the past agricultural treatment, wherein the method further comprises, prior to automatically generating the record:
automatically displaying a query to the user device, the query comprising the first identifier for the past agricultural treatment; and
receiving a confirmation input responsive to the query from the user device; wherein the record is automatically generated based on the confirmation input.

8. The method of claim 6, wherein automatically generating the record based on the confirmation input comprises:
assigning the first identifier as the identifier for the past agricultural treatment in response to the confirmation input comprising a positive confirmation input; and
assigning a second identifier for the past agricultural treatment as the identifier for the past agricultural treatment in response to the confirmation input comprising the second identifier.

9. The method of claim 8, further comprising, in response to receipt of the second identifier for the past agricultural treatment:
calibrating a treatment identification model used to identify the past agricultural treatment, based on the sensor measurements and the second identifier; and
identifying a second past agricultural treatment, using the calibrated treatment identification model, based on a second set of sensor measurements.

10. The method of claim 6, further comprising automatically populating a crop plan associated with the field identifier with the record, wherein automatically populating the crop plan comprises adding the record to a time block of the crop plan corresponding to the treatment time period, wherein the crop plan lacked a scheduled agricultural treatment for the time block.

11. The method of claim 6, further comprising:
for each of a plurality of field identifiers associated with the user account, aggregating a plurality of automatically identified past agricultural treatments for the respective field identifier into a past treatment schedule for the field identifier; and
automatically generating a treatment recommendation for each field identifier of the plurality, based on the respective past treatment schedule.

12. The method of claim 11, wherein the treatment recommendations for each field associated with the user account are further generated based on past weather data for the field.

13. The method of claim 6, wherein the past agricultural treatment is automatically determined based on: the set of sensor measurements, a treatment time associated with the treatment time period, and secondary information associated with the field identifier.

14. The method of claim 13, wherein automatically identifying the past agricultural treatment comprises:
determining a probability for each of a set of possible treatments based on: the set of sensor measurements, a treatment time associated with the treatment time period, and the secondary information associated with the field identifier;
selecting a possible treatment from the set having a high probability as the past agricultural treatment, the possible treatment associated with a treatment identifier; and
assigning the treatment identifier as the identifier for the past agricultural treatment.

15. The method of claim 14, wherein the secondary information associated with the field identifier comprises a predetermined crop plan associating a treatment identifier for a possible treatment with a timeslot corresponding to the treatment time period for the field identifier.

16. The method of claim 6, wherein the set of sensor measurements are recorded by the user device, wherein recording a set of sensor measurements further comprises transmitting the set of sensor measurements to a remote computing device over a wireless connection, wherein the remote computing device automatically identifies the past agricultural treatment and generates the record.

17. The method of claim 6, wherein the user device comprises a data logger comprising a remote navigation system and a wireless connection, the data logger electrically connectable to agricultural equipment.

18. The method of claim 6, wherein the set of sensor measurements comprise user device location measurements.

19. The method of claim 6, wherein the set of sensor measurements comprise user device accelerometer measurements.

20. The method of claim 6, wherein monitoring the user device location comprises, at a remote computing device, receiving an activity update for the user device from a third party at a first time; wherein automatically initiating sensor measurement recordation in response to user device location falling within a predefined geofence comprises:
determining that the user device is located proximal the predefined geofence, based on the activity update;
determining a probability that the user device was associated with agricultural equipment within a predetermined time period before the first time based on the activity update;
automatically determining a high-precision user device location in response to the probability exceeding a probability threshold;
in response to the high-precision user device location falling within the predefined geofence, automatically initiating the sensor measurement recordation; and
in response to the high-precision user device location falling outside the predefined geofence, automatically ceasing high-precision user device location determination.
